(19) United States
(12) Patent Application Publication
(10) Pub. No.: US 2023/0333896 A1
(43) Pub. Date: Oct. 19, 2023

(54) COMPUTING DEVICE AND RELATED METHODS FOR PROVIDING ENHANCED COMPUTING RESOURCE ALLOCATIONS FOR APPLICATIONS

(71) Applicant: CITRIX SYSTEMS, INC., FORT LAUDERDALE, FL (US)

(72) Inventors: WEI ZUO, Nanjing (CN); DAN HU, Nanjing City (CN); ZHENXING LIU, Nanjing (CN)

(21) Appl. No.: 17/664,959

(22) Filed: May 25, 2022

Related U.S. Application Data
(63) Continuation of application No. PCT/CN2022/087590, filed on Apr. 19, 2022.

(51) Int. Cl. G06F 9/50; G06F 11/36

(52) U.S. Cl. CPC G06F 9/5027; G06F 11/3616

(57) ABSTRACT

A computing device may include a memory and a processor coupled to the memory and configured to collect usage activity data across a plurality of different applications for a plurality of users, and determine different groups of users based upon cluster modeling of the usage activity data. The processor may further determine respective application priorities for the applications for each group of users based upon the usage activity data for the group of users, determine computing resource allocations for the applications of each group of users based upon the application priorities for the group of users, and run applications for the users with the computing resource allocations for the respective group of users applied thereto.

### RELATED APPLICATIONS

This application is a continuation of PCT application serial no. PCT/CN2022/087590 filed Apr. 19, 2022, which is hereby incorporated herein in its entirety by reference.

### BACKGROUND

Web applications or apps are software programs that run on a server and are accessed remotely by client devices through a Web browser. That is, while Web applications have a similar functionality to native applications installed directly on the client device, Web applications are instead installed and run on the server, and only the browser application is installed on the client device. Although in some implementations, a hosted browser running on a virtualization server may be used to access Web applications as well.

One advantage of using Web applications is that this allows client devices to run numerous different applications without having to install all of these applications on the client device. This may be particularly beneficial for thin client devices, which typically have reduced memory and processing capabilities. Moreover, updating Web applications may be easier than native applications, as updating is done at the server level rather than having to push out updates to numerous different types of client devices.

Software as a Service (SaaS) is a Web application licensing and delivery model in which applications are delivered remotely as a web-based service, typically on a subscription basis. SaaS is used for delivering several different types of business (and other) applications, including office, database, accounting, customer relation management (CRM), etc.

### SUMMARY

A computing device may include a memory and a processor coupled to the memory and configured to collect usage activity data across a plurality of different applications for a plurality of users, and determine different groups of users based upon cluster modeling of the usage activity data. The processor may further determine respective application priorities for the applications for each group of users based upon the usage activity data for the group of users, determine computing resource allocations for the applications of each group of users based upon the application priorities for the group of users, and run applications for the users with the computing resource allocations for the respective group of users applied thereto.

In one example embodiment, the processor may be further configured to associate new users with an existing group of users based upon user job descriptions. Moreover, the processor may also be configured to move users between existing groups of users over time based upon usage activity for the users, for example. By way of example, the cluster modeling may comprise K-means clustering modeling. In accordance with another example implementation, the processor may be further configured to, prior to determining the different groups of users, determine a number of groups to divide the users into based upon a heuristic algorithm.

In some embodiments, the processor may be configured to determine the computing resource allocations based upon a discriminative model and the usage activity data. By way of example, the computing resource allocations may comprise at least one of random access memory (RAM), central processing unit (CPU), and input/output (I/O) port allocations. In some embodiments, the processor may determine the application priorities based upon at least one of user mouse clicks and user keystrokes, for example. In accordance with another example, the processor may determine the application priorities based upon central processing unit (CPU) usage.

A related method may include, at a computing device, collecting usage activity data across a plurality of different applications for a plurality of users and determining different groups of users based upon cluster modeling of the usage activity data. The method may further include determining respective application priorities for the applications for each group of users based upon the usage activity data for the group of users, determining computing resource allocations for the applications of each group of users based upon the application priorities for the group of users, and running applications for the users with the computing resource allocations for the respective group of users applied thereto.

A related non-transitory computer-readable medium may have computer-executable instructions for causing a computing device to perform steps including collecting usage activity data across a plurality of different applications for a plurality of users, and determining different groups of users based upon cluster modeling of the usage activity data. The steps may further include determining respective application priorities for the applications for each group of users based upon the usage activity data for the group of users, determining computing resource allocations for the applications of each group of users based upon the application priorities for the group of users, and running applications for the users with the computing resource allocations for the respective group of users applied thereto.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a schematic block diagram of a network environment of computing devices in which various aspects of the disclosure may be implemented.

FIG. 2 is a schematic block diagram of a computing device useful for practicing an embodiment of the client machines or the remote machines illustrated in FIG. 1.

FIG. 3 is a schematic block diagram of a cloud computing environment in which various aspects of the disclosure may be implemented.

FIG. 4 is a schematic block diagram of desktop, mobile and web-based devices operating a workspace app in which various aspects of the disclosure may be implemented.

FIG. 5 is a schematic block diagram of a workspace network environment of computing devices in which various aspects of the disclosure may be implemented.

FIG. 6 is a schematic block diagram of a computing device providing enhanced application resource allocations in accordance with an example embodiment.

FIG. 7 is a table of user features in accordance with an example embodiment.

FIG. 8 is a table of app interactivity features in accordance with an example embodiment.

FIG. 9 is a table of app interactivity features in accordance with an example embodiment.

FIG. 10 is a flow diagram illustrating setup of user categories and user activity data by the computing device of FIG. 6 in an example implementation.

FIG. 11 is a table of mappings between users and categories in accordance with an example embodiment.

FIG. 12 is a table listing optimized apps for each user category in an example embodiment.

FIG. 13 is a table of app interactivity features in accordance with another example embodiment.

FIG. 14 is a table of app interactivity features in accordance with still another example embodiment.

FIG. 15 is a schematic block diagram illustrating discriminative model training by the computing device of FIG. 6 in accordance with an example embodiment.

FIG. 16 is a flow diagram illustrating per-user application and optimization parameter determination in accordance with an example embodiment.

FIG. 17 is a table listing optimized apps for each user category in an example embodiment.

FIGS. 18 and 19A-19B are flow diagrams illustrating example method aspects associated with the computing device of FIG. 6.

### DETAILED DESCRIPTION

Various endpoint resource optimization approaches are available to help users improve the performance of specified applications (apps) by adjusting computing resource allocations such as Central Processing Unit (CPU), memory, and/or input/output (I/O) port usage, for example. Citrix Workspace Environment Management is one example of an application optimization system. Despite the capabilities of such systems, it may still be difficult for IT administrators to leverage these capabilities to provide user-oriented optimizations for various reasons. One such reason is that it may be difficult to cover all applications that end users might use. In practice, administrators need to identify a process list to be optimized for a user group, but this typically requires domain knowledge, and such process lists can be difficult to maintain. Furthermore, it may be difficult to tune the optimization parameters to comply with a given user’s personal behaviors. For example, User A may tend to use build tools within Integrated Development Environment (IDE) software while User B prefers to use a separate build tool. Then for User A, the IDE software should be assigned with more resources while for User B, both the IDE software and the build tool should be optimized with proper weights, which may be difficult to recognize and set manually by IT personnel.

The approach set forth herein advantageously overcomes these technical challenges by providing for automated app optimization for users though unsupervised machine learning. More particularly, users may be divided into different groups based upon cluster modeling of their usage activity data, and then respective application priorities and computing resource allocations may be determined for each group. The group computing resource allocations may be applied to applications for respective group members upon running of the applications, and refined for individual users over time based upon user activity data, which may include user feedback.

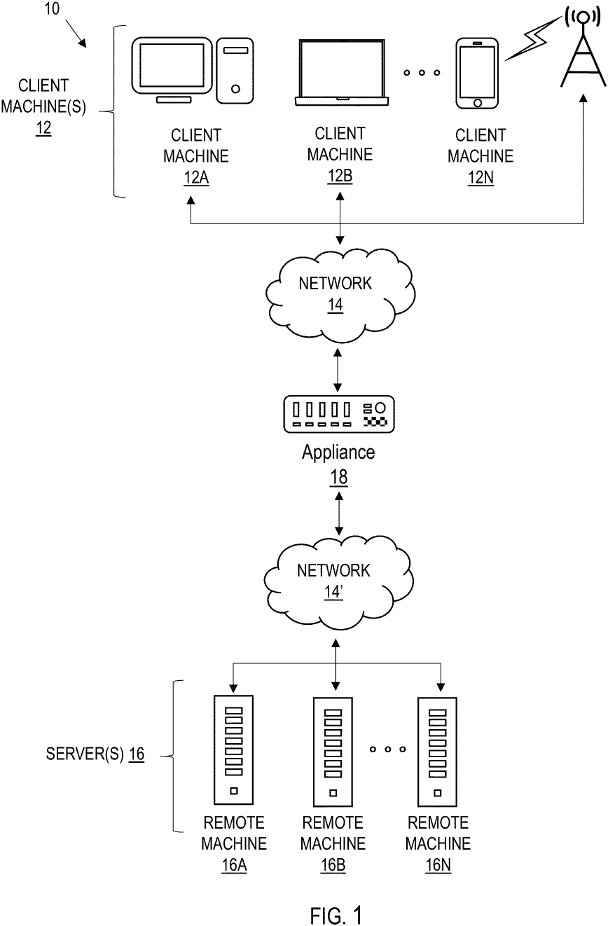

Referring initially to FIG. 1, a non-limiting network environment 10 in which various aspects of the disclosure may be implemented includes one or more client machines 12A-12N, one or more remote machines 16A-16N, one or more networks 14, 14′, and one or more appliances 18 installed within the computing environment 10. The client machines 12A-12N communicate with the remote machines 16A-16N via the networks 14, 14′.

In some embodiments, the client machines 12A-12N communicate with the remote machines 16A-16N via an intermediary appliance 18. The illustrated appliance 18 is positioned between the networks 14, 14′ and may also be referred to as a network interface or gateway. In some embodiments, the appliance 108 may operate as an application delivery controller (ADC) to provide clients with access to business applications and other data deployed in a data center, the cloud, or delivered as Software as a Service (SaaS) across a range of client devices, and/or provide other functionality such as load balancing, etc. In some embodiments, multiple appliances 18 may be used, and the appliance(s) 18 may be deployed as part of the network 14 and/or 14′ .

The client machines 12A-12N may be generally referred to as client machines 12, local machines 12, clients 12, client nodes 12, client computers 12, client devices 12, computing devices 12, endpoints 12, or endpoint nodes 12. The remote machines 16A-16N may be generally referred to as servers 16 or a server farm 16. In some embodiments, a client device 12 may have the capacity to function as both a client node seeking access to resources provided by a server 16 and as a server 16 providing access to hosted resources for other client devices 12A-12N. The networks 14, 14′ may be generally referred to as a network 14. The networks 14 may be configured in any combination of wired and wireless networks.

A server 16 may be any server type such as, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality.

A server 16 may execute, operate or otherwise provide an application that may be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other set of executable instructions.

In some embodiments, a server 16 may execute a remote presentation services program or other program that uses a thin-client or a remote-display protocol to capture display output generated by an application executing on a server 16 and transmit the application display output to a client device 12.

In yet other embodiments, a server 16 may execute a virtual machine providing, to a user of a client device 12, access to a computing environment. The client device 12 may be a virtual machine. The virtual machine may be managed by, for example, a hypervisor, a virtual machine manager (VMM), or any other hardware virtualization technique within the server 16.

In some embodiments, the network 14 may be: a local-area network (LAN); a metropolitan area network (MAN); a wide area network (WAN); a primary public network 14; and a primary private network 14. Additional embodiments may include a network 14 of mobile telephone networks that use various protocols to communicate among mobile devices. For short range communications within a wireless local-area network (WLAN), the protocols may include 802.11, Bluetooth, and Near Field Communication (NFC).

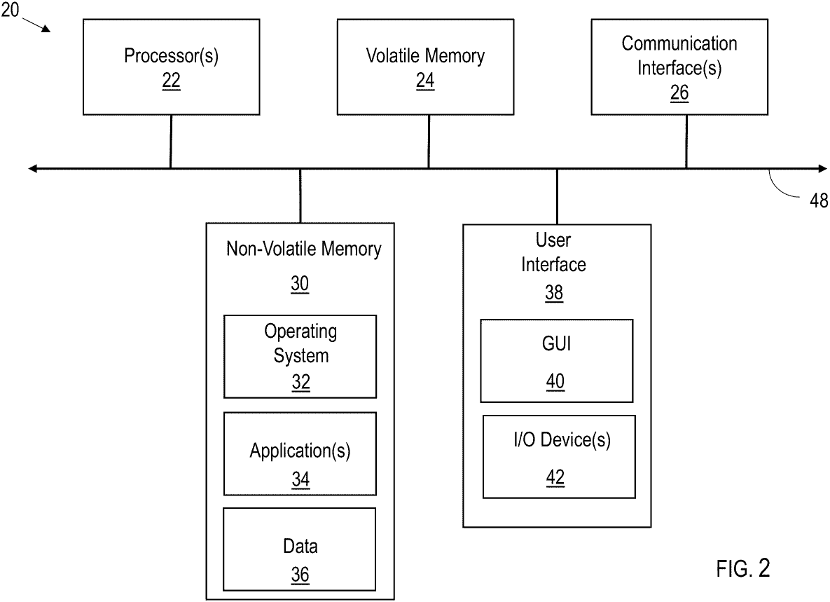

FIG. 2 depicts a block diagram of a computing device 20 useful for practicing an embodiment of client devices 12, appliances 18 and/or servers 16. The computing device 20 includes one or more processors 22, volatile memory 24 (e.g., random access memory (RAM)), non-volatile memory 30, user interface (UI) 38, one or more communications interfaces 26, and a communications bus 48.

The non-volatile memory 30 may include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

The user interface 38 may include a graphical user interface (GUI) 40 (e.g., a touchscreen, a display, etc.) and one or more input/output (I/O) devices 42 (e.g., a mouse, a keyboard, a microphone, one or more speakers, one or more cameras, one or more biometric scanners, one or more environmental sensors, and one or more accelerometers, etc.).

The non-volatile memory 30 stores an operating system 32, one or more applications 34, and data 36 such that, for example, computer instructions of the operating system 32 and/or the applications 34 are executed by processor(s) 22 out of the volatile memory 24. In some embodiments, the volatile memory 24 may include one or more types of RAM and/or a cache memory that may offer a faster response time than a main memory. Data may be entered using an input device of the GUI 40 or received from the I/O device(s) 42. Various elements of the computer 20 may communicate via the communications bus 48.

The illustrated computing device 20 is shown merely as an example client device or server, and may be implemented by any computing or processing environment with any type of machine or set of machines that may have suitable hardware and/or software capable of operating as described herein.

The processor(s) 22 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A processor may perform the function, operation, or sequence of operations using digital values and/or using analog signals.

In some embodiments, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory.

The processor 22 may be analog, digital or mixed-signal. In some embodiments, the processor 22 may be one or more physical processors, or one or more virtual (e.g., remotely located or cloud) processors. A processor including multiple processor cores and/or multiple processors may provide functionality for parallel, simultaneous execution of instructions or for parallel, simultaneous execution of one instruction on more than one piece of data.

The communications interfaces 26 may include one or more interfaces to enable the computing device 20 to access a computer network such as a Local Area Network (LAN), a Wide Area Network (WAN), a Personal Area Network (PAN), or the Internet through a variety of wired and/or wireless connections, including cellular connections.

In described embodiments, the computing device 20 may execute an application on behalf of a user of a client device. For example, the computing device 20 may execute one or more virtual machines managed by a hypervisor. Each virtual machine may provide an execution session within which applications execute on behalf of a user or a client device, such as a hosted desktop session. The computing device 20 may also execute a terminal services session to provide a hosted desktop environment. The computing device 20 may provide access to a remote computing environment including one or more applications, one or more desktop applications, and one or more desktop sessions in which one or more applications may execute.

An example virtualization server 16 may be implemented using Citrix Hypervisor provided by Citrix Systems, Inc., of Fort Lauderdale, Florida (“Citrix Systems”). Virtual app and desktop sessions may further be provided by Citrix Virtual Apps and Desktops (CVAD), also from Citrix Systems. Citrix Virtual Apps and Desktops is an application virtualization solution that enhances productivity with universal access to virtual sessions including virtual app, desktop, and data sessions from any device, plus the option to implement a scalable VDI solution. Virtual sessions may further include Software as a Service (SaaS) and Desktop as a Service (DaaS) sessions, for example.

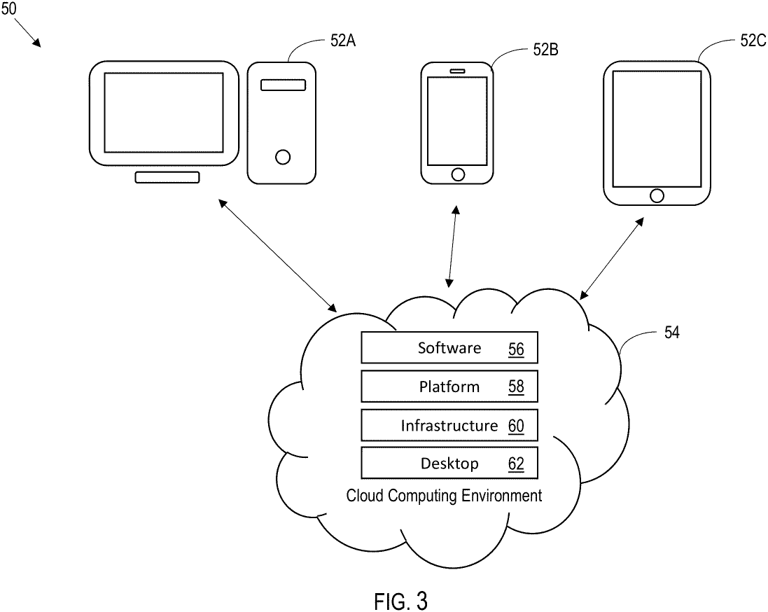

Referring to FIG. 3, a cloud computing environment 50 is depicted, which may also be referred to as a cloud environment, cloud computing or cloud network. The cloud computing environment 50 can provide the delivery of shared computing services and/or resources to multiple users or tenants. For example, the shared resources and services can include, but are not limited to, networks, network bandwidth, servers, processing, memory, storage, applications, virtual machines, databases, software, hardware, analytics, and intelligence.

In the cloud computing environment 50, one or more clients 52A-52C (such as those described above) are in communication with a cloud network 54. The cloud network 54 may include backend platforms, e.g., servers, storage, server farms or data centers. The users or clients 52A-52C can correspond to a single organization/tenant or multiple organizations/tenants. More particularly, in one example implementation the cloud computing environment 50 may provide a private cloud serving a single organization (e.g., enterprise cloud). In another example, the cloud computing environment 50 may provide a community or public cloud serving multiple organizations/ tenants. In still further embodiments, the cloud computing environment 50 may provide a hybrid cloud that is a combination of a public cloud and a private cloud. Public clouds may include public servers that are maintained by third parties to the clients 52A-52C or the enterprise/tenant. The servers may be located off-site in remote geographical locations or otherwise.

The cloud computing environment 50 can provide resource pooling to serve multiple users via clients 52A-52C through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In some embodiments, the cloud computing environment 50 can provide on-demand self-service to unilaterally provision computing capabilities (e.g., server time, network storage) across a network for multiple clients 52A-52C. The cloud computing environment 50 can provide an elasticity to dynamically scale out or scale in responsive to different demands from one or more clients 52. In some embodiments, the computing environment 50 can include or provide monitoring services to monitor, control and/or generate reports corresponding to the provided shared services and resources.

In some embodiments, the cloud computing environment 50 may provide cloud-based delivery of different types of cloud computing services, such as Software as a service (SaaS) 56, Platform as a Service (PaaS) 58, Infrastructure as a Service (IaaS) 60, and Desktop as a Service (DaaS) 62, for example. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Washington, RACKSPACE CLOUD provided by Rackspace US, Inc., of San Antonio, Texas, Google Compute Engine provided by Google Inc. of Mountain View, California, or RIGHTSCALE provided by RightScale, Inc., of Santa Barbara, California.

PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Washington, Google App Engine provided by Google Inc., and HEROKU provided by Heroku, Inc. of San Francisco, California.

SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, California, or OFFICE 365 provided by Microsoft Corporation. Examples of SaaS may also include data storage providers, e.g. DROPBOX provided by Dropbox, Inc. of San Francisco, California, Microsoft SKYDRIVE provided by Microsoft Corporation, Google Drive provided by Google Inc., or Apple ICLOUD provided by Apple Inc. of Cupertino, California.

Similar to SaaS, DaaS (which is also known as hosted desktop services) is a form of virtual desktop infrastructure (VDI) in which virtual desktop sessions are typically delivered as a cloud service along with the apps used on the virtual desktop. Citrix Cloud is one example of a DaaS delivery platform. DaaS delivery platforms may be hosted on a public cloud computing infrastructure such as AZURE CLOUD from Microsoft Corporation of Redmond, Washington (herein “Azure”), or AMAZON WEB SERVICES provided by Amazon.com, Inc., of Seattle, Washington (herein “AWS”), for example. In the case of Citrix Cloud, Citrix Workspace app may be used as a single-entry point for bringing apps, files and desktops together (whether on-premises or in the cloud) to deliver a unified experience.

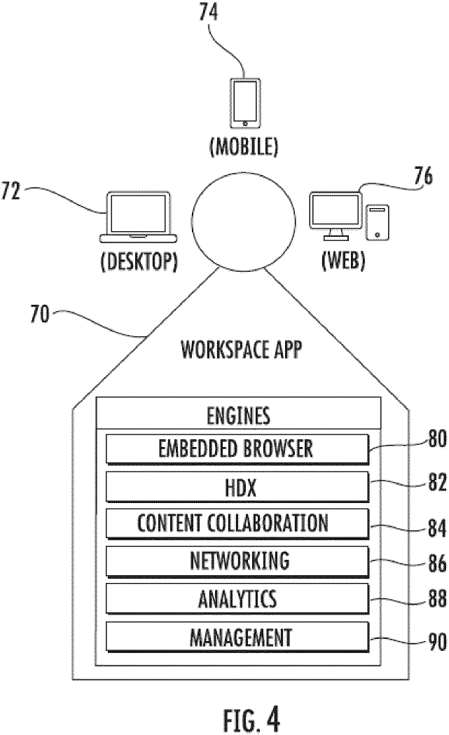

The unified experience provided by the Citrix Workspace app will now be discussed in greater detail with reference to FIG. 4. The Citrix Workspace app will be generally referred to herein as the workspace app 70. The workspace app 70 is how a user gets access to their workspace resources, one category of which is applications. These applications can be SaaS apps, web apps or virtual apps. The workspace app 70 also gives users access to their desktops, which may be a local desktop or a virtual desktop. Further, the workspace app 70 gives users access to their files and data, which may be stored in numerous repositories. The files and data may be hosted on Citrix ShareFile, hosted on an on-premises network file server, or hosted in some other cloud storage provider, such as Microsoft OneDrive or Google Drive Box, for example.

To provide a unified experience, all of the resources a user requires may be located and accessible from the workspace app 70. The workspace app 70 is provided in different versions. One version of the workspace app 70 is an installed application for desktops 72, which may be based on Windows, Mac or Linux platforms. A second version of the workspace app 70 is an installed application for mobile devices 74, which may be based on iOS or Android platforms. A third version of the workspace app 70 uses a hypertext markup language (HTML) browser to provide a user access to their workspace environment. The web version of the workspace app 70 is used when a user does not want to install the workspace app or does not have the rights to install the workspace app, such as when operating a public kiosk 76.

Each of these different versions of the workspace app 70 may advantageously provide the same user experience. This advantageously allows a user to move from client device 72 to client device 74 to client device 76 in different platforms and still receive the same user experience for their workspace. The client devices 72, 74 and 76 are referred to as endpoints.

As noted above, the workspace app 70 supports Windows, Mac, Linux, iOS, and Android platforms as well as platforms with an HTML browser (HTML5). The workspace app 70 incorporates multiple engines 80-90 allowing users access to numerous types of app and data resources. Each engine 80-90 optimizes the user experience for a particular resource. Each engine 80-90 also provides an organization or enterprise with insights into user activities and potential security threats.

An embedded browser engine 80 keeps SaaS and web apps contained within the workspace app 70 instead of launching them on a locally installed and unmanaged browser. With the embedded browser, the workspace app 70 is able to intercept user-selected hyperlinks in SaaS and web apps and request a risk analysis before approving, denying, or isolating access.

A high definition experience (HDX) engine 82 establishes connections to virtual browsers, virtual apps and desktop sessions running on either Windows or Linux operating systems. With the HDX engine 82, Windows and Linux resources run remotely, while the display remains local, on the endpoint. To provide the best possible user experience, the HDX engine 82 utilizes different virtual channels to adapt to changing network conditions and application requirements. To overcome high-latency or high-packet loss networks, the HDX engine 82 automatically implements optimized transport protocols and greater compression algorithms. Each algorithm is optimized for a certain type of display, such as video, images, or text. The HDX engine 82 identifies these types of resources in an application and applies the most appropriate algorithm to that section of the screen.

For many users, a workspace centers on data. A content collaboration engine 84 allows users to integrate all data into the workspace, whether that data lives on-premises or in the cloud. The content collaboration engine 84 allows administrators and users to create a set of connectors to corporate and user-specific data storage locations. This can include OneDrive, Dropbox, and on-premises network file shares, for example. Users can maintain files in multiple repositories and allow the workspace app 70 to consolidate them into a single, personalized library.

A networking engine 86 identifies whether or not an endpoint or an app on the endpoint requires network connectivity to a secured backend resource. The networking engine 86 can automatically establish a full VPN tunnel for the entire endpoint device, or it can create an app-specific µ-VPN connection. A µ-VPN defines what backend resources an application and an endpoint device can access, thus protecting the backend infrastructure. In many instances, certain user activities benefit from unique network-based optimizations. If the user requests a file copy, the workspace app 70 can automatically utilize multiple network connections simultaneously to complete the activity faster. If the user initiates a VoIP call, the workspace app 70 improves its quality by duplicating the call across multiple network connections. The networking engine 86 uses only the packets that arrive first.

An analytics engine 88 reports on the user’s device, location and behavior, where cloud-based services identify any potential anomalies that might be the result of a stolen device, a hacked identity or a user who is preparing to leave the company. The information gathered by the analytics engine 88 protects company assets by automatically implementing countermeasures.

A management engine 90 keeps the workspace app 70 current. This not only provides users with the latest capabilities, but also includes extra security enhancements. The workspace app 70 includes an auto-update service that routinely checks and automatically deploys updates based on customizable policies.

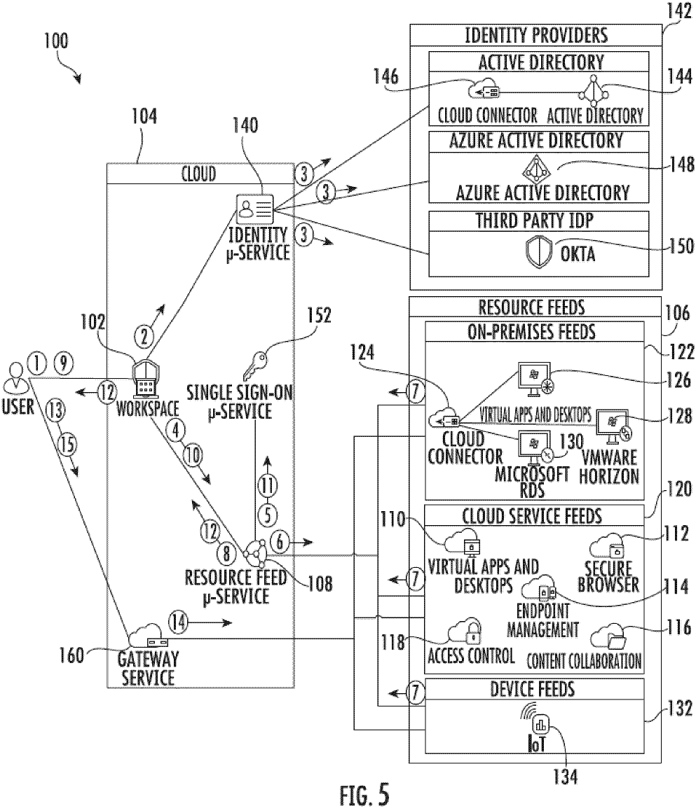

Referring now to FIG. 5, a workspace network environment 100 providing a unified experience to a user based on the workspace app 70 will be discussed. The desktop, mobile and web versions of the workspace app 70 all communicate with the workspace experience service 102 running within the Cloud 104. The workspace experience service 102 then pulls in all the different resource feeds 16 via a resource feed micro-service 108. That is, all the different resources from other services running in the Cloud 104 are pulled in by the resource feed micro-service 108. The different services may include a virtual apps and desktop service 110, a secure browser service 112, an endpoint management service 114, a content collaboration service 116, and an access control service 118. Any service that an organization or enterprise subscribes to are automatically pulled into the workspace experience service 102 and delivered to the user’s workspace app 70.

In addition to cloud feeds 120, the resource feed micro-service 108 can pull in on-premises feeds 122. A cloud connector 124 is used to provide virtual apps and desktop deployments that are running in an on-premises data center. Desktop virtualization may be provided by Citrix virtual apps and desktops 126, Microsoft RDS 128 or VMware Horizon 130, for example. In addition to cloud feeds 120 and on-premises feeds 122, device feeds 132 from Internet of Thing (IoT) devices 134, for example, may be pulled in by the resource feed micro-service 108. Site aggregation is used to tie the different resources into the user’s overall workspace experience.

The cloud feeds 120, on-premises feeds 122 and device feeds 132 each provides the user’s workspace experience with a different and unique type of application. The workspace experience can support local apps, SaaS apps, virtual apps, and desktops browser apps, as well as storage apps. As the feeds continue to increase and expand, the workspace experience is able to include additional resources in the user’s overall workspace. This means a user will be able to get to every single application that they need access to.

Still referring to the workspace network environment 20, a series of events will be described on how a unified experience is provided to a user. The unified experience starts with the user using the workspace app 70 to connect to the workspace experience service 102 running within the Cloud 104, and presenting their identity (event 1). The identity includes a username and password, for example.

The workspace experience service 102 forwards the user’s identity to an identity micro-service 140 within the Cloud 104 (event 2). The identity micro-service 140 authenticates the user to the correct identity provider 142 (event 3) based on the organization’s workspace configuration. Authentication may be based on an on-premises active directory 144 that requires the deployment of a cloud connector 146. Authentication may also be based on Azure Active Directory 148 or even a third party identity provider 150, such as Citrix ADC or Okta, for example.

Once authorized, the workspace experience service 102 requests a list of authorized resources (event 4) from the resource feed micro-service 108. For each configured resource feed 106, the resource feed micro-service 108 requests an identity token (event 5) from the single-sign micro-service 152.

The resource feed specific identity token is passed to each resource’s point of authentication (event 6). On-premises resources 122 are contacted through the Cloud Connector 124. Each resource feed 106 replies with a list of resources authorized for the respective identity (event 7).

The resource feed micro-service 108 aggregates all items from the different resource feeds 106 and forwards (event 8) to the workspace experience service 102. The user selects a resource from the workspace experience service 102 (event 9).

The workspace experience service 102 forwards the request to the resource feed micro-service 108 (event 10). The resource feed micro-service 108 requests an identity token from the single sign-on micro-service 152 (event 11). The user’s identity token is sent to the workspace experience service 102 (event 12) where a launch ticket is generated and sent to the user.

The user initiates a secure session to a gateway service 160 and presents the launch ticket (event 13). The gateway service 160 initiates a secure session to the appropriate resource feed 106 and presents the identity token to seamlessly authenticate the user (event 14). Once the session initializes, the user is able to utilize the resource (event 15). Having an entire workspace delivered through a single access point or application advantageously improves productivity and streamlines common workflows for the user.

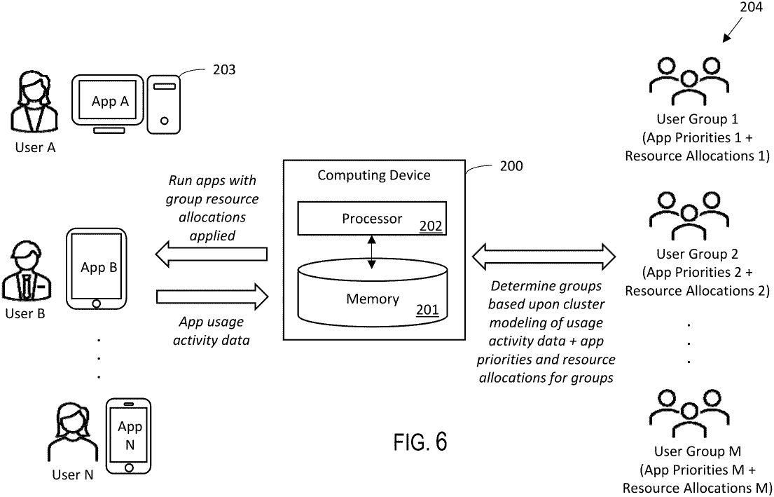

Turning now to FIG. 6, a computing device 200 provides for automated app optimization for users though unsupervised machine learning. The computing device illustratively includes a memory 201 and a processor 202 coupled to the memory and configured to collect usage activity data across a plurality of different applications (Apps A-N) at client computing devices 203 for a plurality of users (Users A-N), and determine different groups 204 (here User Groups 1-M) of users based upon cluster modeling of the usage activity data. The processor 202 further determines respective application priorities for the applications for each group of users based upon the usage activity data for the group of users, determines computing resource allocations for the applications of each group of users based upon the application priorities for the group of users, and runs applications for the users with the computing resource allocations for the respective group of users applied thereto.

By way of example, the computing device 200 may be implemented as one or more servers (e.g., on premises or in the cloud), and the processor 202 may be implemented with a microprocessor(s) and associated hardware. The memory 201 may comprise a non-transitory computer-readable medium(s) having computer-executable instructions for causing the processor 202 to perform the operations described herein. Furthermore, the approach set forth herein may be implemented as part of Citrix Workspace described above, e.g., within Citrix Workspace Environment Management, although it may be implemented in other suitable platforms in different embodiments.

In an example embodiment, the computing device 200 may determine application user affinity, which measures how heavy a user uses an application. For example, a software engineer might be a heavy user of development tools such as Virtual Studio (VS) Code, whereas a graphic designer could be a heavy user of AutoCAD. As such, VS code has high affinity for the software engineer, and AutoCAD has high affinity for the graphic designer. Higher affinity is meant to optimize the application with a higher priority. Affinities can be determined through user activity data. The following formula is one example approach to calculate affinity (notated as A) for a specific application based on user interactivity and process runtime information:

$$A = \frac{1}{1 + {e}^{- \left(+ {μ}_{1 \text{} M} + {μ}_{2 K} + {μ}_{3 C} + {μ}_{4 P} + {μ}_{5 N} + {μ}_{6 W} + {μ}_{7 T}\right)}}$$

where M = number of user mouse clicks per minute; K = number of user key strikes per minute; C = average CPU usage per minute; P = peak CPU usage per minute; N = network traffic like the number of packages received per minute; W = device I/O such as per-minute read/write or I/O requests per minute; and T = window activated time per minute. The values of M, K, C, P, N, W, and T may be normalized for data normalization. The values of µᵢ(ₛ) are used to adjust weights across different factors for prioritization. It should be noted that this is but one example approach, and that in other embodiments other numbers of variables and approaches for affinity determination may be used.

In addition to determining user affinity, the present approach also divides users into respective categories. More particularly, a user category is a group of users which perform similar activities, thus users in the same category may share the same list of applications being optimized. However, even for Research and Development (R_{&}D) staff, user behaviors may still vary widely. For example, for computer programming, even for Windows developers the Integrated Development Environments (IDEs) they are used to (e.g., Visual Studio, VS Code, Eclipse, IntelliJ, etc.) can be different, not to mention developers for different Operating System (OS) platforms (e.g., Windows, Linux, Mac, Android, etc.). As such, manually defined user categories tend to be inaccurate.

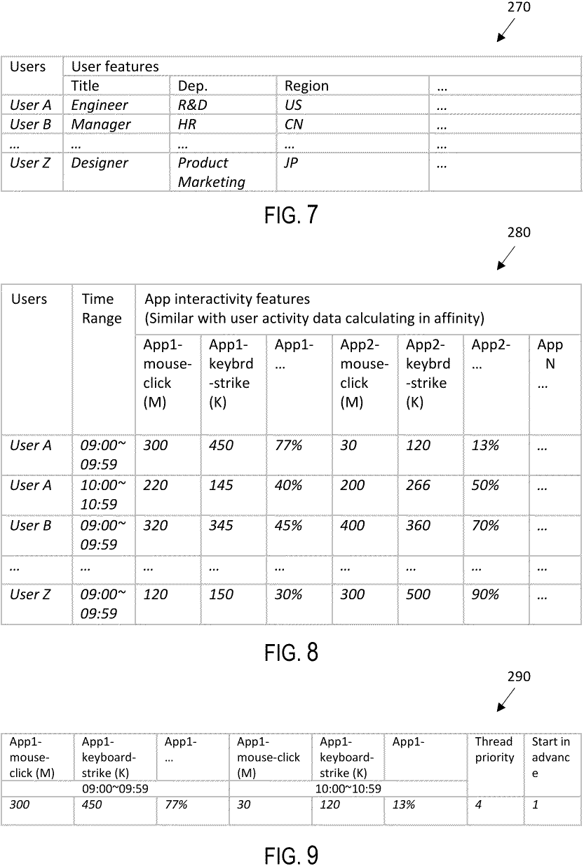

Accordingly, the user categories or groups defined herein need not be constrained to employee groups such as R&D, finance, Human Resources (HR), etc., but instead may traverse different employee groupings to determine users with similar usage patters irrespective of the employee classification. That is, user categories may be determined based upon user activities, with example user activity data including both “user features” and “app interactivity features”, an example of which is shown in tables 270 and 280 of FIGS. 7 and 8. To involve more dimensions, user activity may be divided by time range. With large amounts of user activity data, user categories could be automatically determined through an unsupervised approach, such as cluster modeling (e.g., K-means, etc.).

In an example approach, optimization parameters may be used for optimizing an application for a specific user, such as process/thread priority, whether starting in advance, etc. It is typically difficult for an IT administrator to figure out those parameters manually, and the present approach helps to automatically determine those parameters based on user feedback data. For example, if feedback from a user indicates that App1 is not responsive enough, then App1 may be boosted to a higher thread priority. Based upon sufficient amounts of such feedback data, a discriminative model may be trained by the computing device 200 to determine the best optimization parameters. An example training data set is shown in the table 290 of FIG. 9, where for the mouse/keyboard/CPU usage data, it is suggested to set the thread priority to 4 and start it in advance to gain a desired user experience. This is done according to the “app interactivity features”, in which App1 is assigned the illustrated optimization parameters for User A.

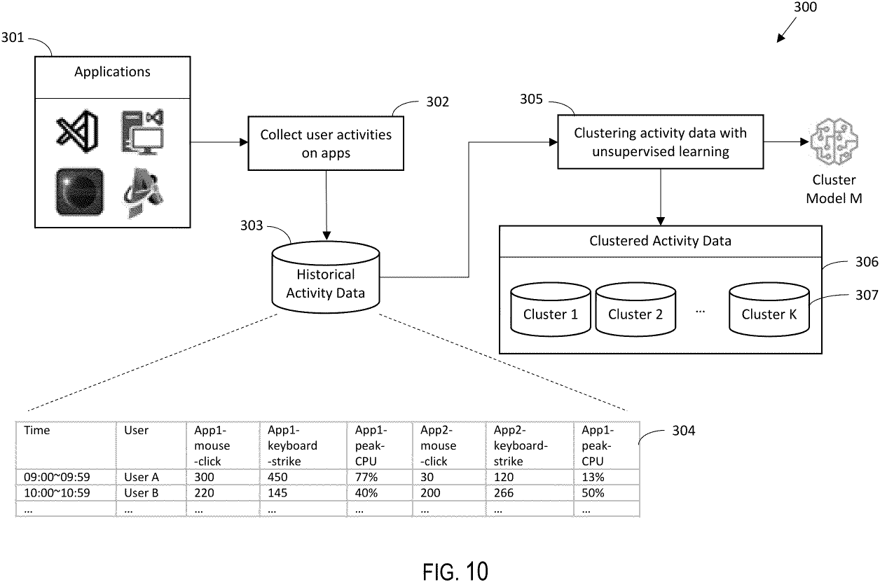

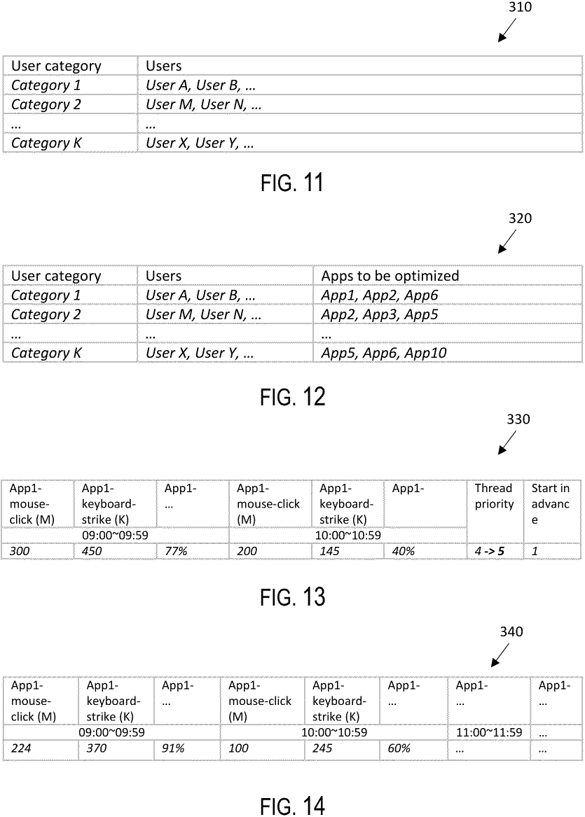

Turning to FIGS. 10-17, an example approach to automated app optimization is now described. In the flow diagram 300, user activity data associated with apps 301 is collected (Block 302) and saved into a historical activity data database 303. This data may be transformed and organized as shown in the table 304. Then an unsupervised learning approach (e.g., cluster modeling such as K-means, etc.) is applied (Block 305) to the organized data to train a cluster model M in which clustered activity data 306 is clustered into K clusters 307. To make the cluster model M fit the latest data, this step may be repeated periodically (e.g., every three to six months), and data from the past three to six months may be used to generate the cluster model M as well as the data clusters 307, although different time periods may be used in different embodiments. In some embodiments, a heuristic algorithm (e.g., Elbow or Silhouette method, etc.) may be used to determine the optimum number of clusters or groups (i.e., the value of K) to divide the users into before generating the cluster model M. An example mapping between users and categories is shown in the table 310 of FIG. 11.

A next step involves calculating application user affinity per user category, as discussed above. The K clusters 307 discussed above are treated as data for K user categories. Then, for each category, the affinity formula above is used to calculate an affinity for each app. These applications may then be optimized according to their affinities. Example approaches to selecting which applications are to be optimized is to pick the top N applications in terms of affinity, or select those with affinities being over a pre-defined threshold. An example optimized app list for each user category is shown in table 320 of FIG. 12.

The next step in the process is to build a discriminative model D per user category. Initially those optimization parameters may be set with default values. For example, feedback data may be collected through a Customer Experience Improvement Program (CEIP). By way of example, if a value of “4” is used for processing thread priority, and start-in-advance is enabled (value = “1”) as the current optimization parameters for App1 based upon the App1 user activity data, if a user’s feedback for the app is positive, this data item will be used as training data directly. If the user responds that he needs further optimization for App1, then thread priority is boosted to 5, which is then used as training data, as shown in table 330 of FIG. 13. As noted above, sufficient amounts of data can be used to train a discriminative model D. With the discriminative model, for each new data item such as the one shown in the table 340 of FIG. 14, the best parameters can be inferred, e.g., thread priority, start in advance (e.g., start the program as soon as the user logs in instead of waiting on the user to select the program), etc.

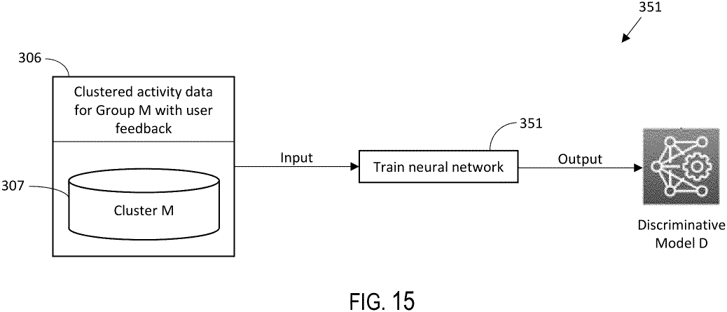

An approach for training the discriminative model D is shown in flow diagram 350 of FIG. 15. The clustered activity data for a given group 307 (here Group M) with user feedback is provided as the input to a machine learning model, such as a neural network, for example, at Block 351, which generates the discriminative model D for the cluster. It should be noted that other suitable machine learning models may be used in different embodiments, if desired.

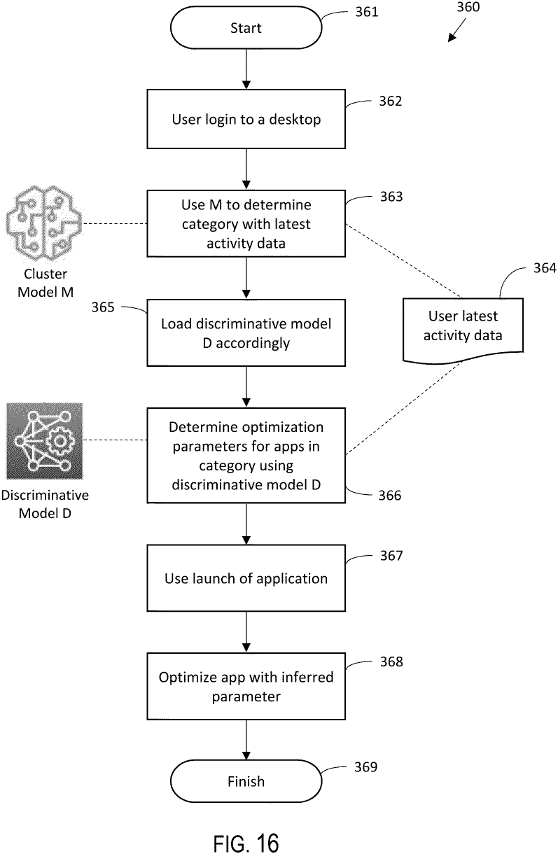

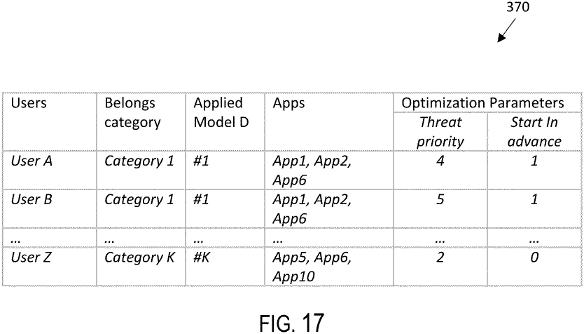

With the cluster model M and discriminative model D known, the next step in the approach is to determine per-user applications and optimization parameters. More particularly, beginning at Block 361, after user login (Block 362), cluster model M is used to determine the user category (Block 363) with the user’s latest activity data 364 (e.g., the past three days). If it is a new user, then a “default” category may be used, e.g., by selecting a user category where there is another user who belongs to the same department of the company or has the same job title as the new user. The category includes the optimized app list, and the discriminative model D of that user category is loaded (Block 365), which is used to determine the optimization parameters for each application and optimize them when they are launched, at Block 366-368, which concludes the method illustrated in FIG. 16 (Block 369). An example optimized app list for each user is shown in the table 370 of FIG. 17.

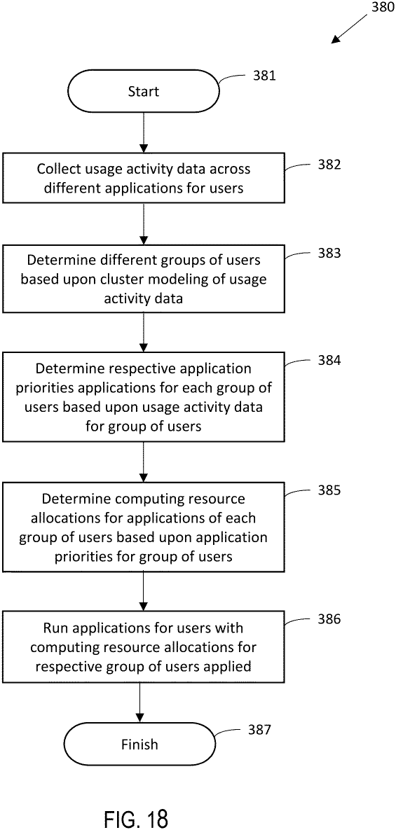

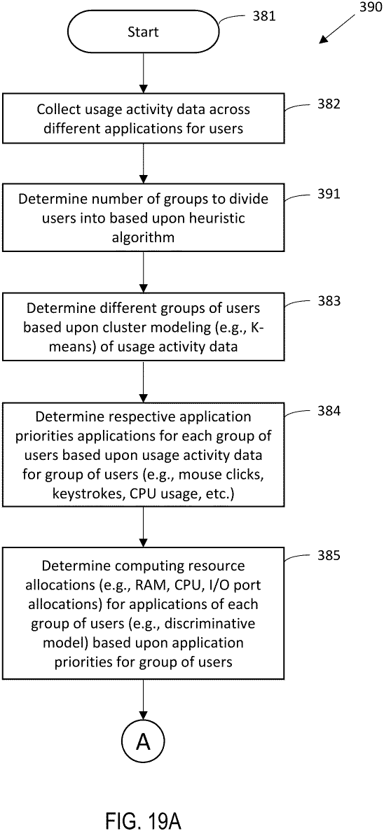

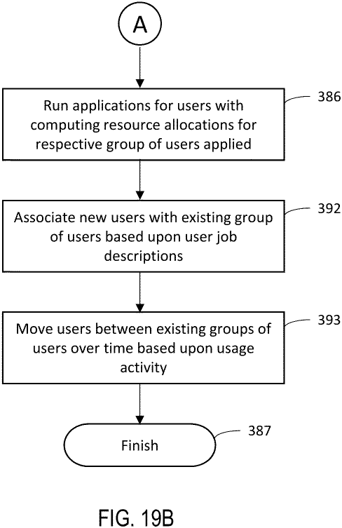

Related method aspects are now described with reference to the flow diagrams 380 and 390 of FIGS. 18 and 19A-19B. Beginning at Block 381, the computing device 200 collects usage activity data across a plurality of different applications (Apps A-N) for a plurality of users (Users A-N), at Block 382, and determines different groups of users based upon cluster modeling of the usage activity data, at Block 383. The method further illustratively includes determining respective application priorities for the applications for each group of users based upon the usage activity data for the group of users (Block 384), determining computing resource allocations for the applications of each group of users based upon the application priorities for the group of users (Block 385), and running applications for the users with the computing resource allocations for the respective group of users applied thereto (Block 386), as discussed further above. The method of FIG. 18 illustratively concludes at Block 387.

In some embodiments, prior to determining the different groups of users, the computing device 200 may determine a number of groups to divide the users into based upon a heuristic algorithm (e.g., Elbow or Silhouette method, etc.), at Block 391, as discussed further above. Furthermore, in some implementations new users may be associated with an existing group of users based upon user job descriptions, etc., at Block 392. Moreover, new (and existing) users may be moved between existing groups of users over time based upon usage activity for the users, at Block 393, for example.

As will be appreciated by one of skill in the art upon reading the foregoing disclosure, various aspects described herein may be embodied as a device, a method or a computer program product (e.g., a non-transitory computer-readable medium having computer executable instruction for performing the noted operations or steps). Accordingly, those aspects may take the form of an entirely hardware embodiment, an entirely software embodiment, or an embodiment combining software and hardware aspects.

Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof.

Many modifications and other embodiments will come to the mind of one skilled in the art having the benefit of the teachings presented in the foregoing descriptions and the associated drawings. Therefore, it is understood that the foregoing is not to be limited to the example embodiments, and that modifications and other embodiments are intended to be included within the scope of the appended claims.

1. A computing device comprising:
a memory and a processor coupled to the memory and configured to
collect usage activity data across a plurality of different applications for a plurality of users,
determine different groups of users based upon cluster modeling of the usage activity data,
determine respective application priorities for the applications for each group of users based upon the usage activity data for the group of users,
determine computing resource allocations for the applications of each group of users based upon the application priorities for the group of users, and
run applications for the users with the computing resource allocations for the respective group of users applied thereto.

2. The computing device of claim 1 wherein the processor is further configured to associate new users with an existing group of users based upon user job descriptions.

3. The computing device of claim 1 wherein the processor is further configured to move the users between existing groups of users over time based upon usage activity.

4. The computing device of claim 1 wherein the cluster modeling comprises K-means clustering modeling.

5. The computing device of claim 1 wherein the processor is further configured to, prior to determining the different groups of users, determine a number of groups to divide the users into based upon a heuristic algorithm.

6. The computing device of claim 1 wherein the processor is configured to determine the computing resource allocations based upon a discriminative model and the usage activity data.

7. The computing device of claim 1 wherein the computing resource allocations comprise at least one of random access memory (RAM), central processing unit (CPU), and input/output (I/O) port allocations.

8. The computing device of claim 1 wherein the processor determines the application priorities based upon at least one of user mouse clicks and user keystrokes.

9. The computing device of claim 1 wherein the processor determines the application priorities based upon central processing unit (CPU) usage.

10. A method comprising:
at a computing device,
collecting usage activity data across a plurality of different applications for a plurality of users;
determining different groups of users based upon cluster modeling of the usage activity data;
determining respective application priorities for the applications for each group of users based upon the usage activity data for the group of users;
determining computing resource allocations for the applications of each group of users based upon the application priorities for the group of users; and
running applications for the users with the computing resource allocations for the respective group of users applied thereto.

11. The method of claim 10 further comprising, at the computing device:
associating new users with an existing group of users based upon user job descriptions; and
moving the new users between existing groups of users over time based upon usage activity for the new users.

12. The method of claim 10 wherein the cluster modeling comprises K-means clustering modeling.

13. The method of claim 10 further comprising, prior to determining the different groups of users, determining a number of groups to divide the users into based upon a heuristic algorithm at the computing device.

14. The method of claim 10 wherein determining the computing resource allocations comprises determining the computing resource allocations based upon a discriminative model and the usage activity data.

15. The method of claim 10 wherein the computing resource allocations comprise at least one of random access memory (RAM), central processing unit (CPU), and input/output (I/O) port allocations.

16. A non-transitory computer-readable medium having computer-executable instructions for causing a computing device to perform steps comprising:
collecting usage activity data across a plurality of different applications for a plurality of users;
determining different groups of users based upon cluster modeling of the usage activity data;
determining respective application priorities for the applications for each group of users based upon the usage activity data for the group of users;
determining computing resource allocations for the applications of each group of users based upon the application priorities for the group of users; and
running applications for the users with the computing resource allocations for the respective group of users applied thereto.

17. The non-transitory computer-readable medium of claim 16 further having computer executable instructions for causing the computing device to perform steps comprising:
associating new users with an existing group of users based upon user job descriptions; and
moving the new users between existing groups of users over time based upon usage activity for the new users.

18. The non-transitory computer-readable medium of claim 16 wherein the cluster modeling comprises K-means clustering modeling.

19. The non-transitory computer-readable medium of claim 16 further having computer-executable instructions for causing the computing device to perform a step of, prior to determining the different groups of users, determining a number of groups to divide the users into based upon a heuristic algorithm at the computing device.

20. The non-transitory computer-readable medium of claim 16 wherein determining the computing resource allocations comprises determining the computing resource allocations based upon a discriminative model and the usage activity data.
